(19) United States
(12) Patent Application Publication
(10) Pub. No.: US 2026/0228546 A1
(43) Pub. Date: Aug. 6, 2026

(54) MULTI-AGENT COLLABORATION VIA JOINT MODEL STEERING

(71) Applicant: GDM Holding LLC, Mountain View, CA (US)

(72) Inventors: Florian Nils Hartmann, Zurich (CH); Matthew Sharifi, Kilchberg (CH)

(21) Appl. No.: 19/045,417

(22) Filed: Feb. 4, 2025

(51) Int. Cl. G06N 3/092; G06N 3/045; G06N 3/048

(52) U.S. Cl. CPC G06N 3/092; G06N 3/045; G06N 3/048

(57) ABSTRACT

A computer-implemented method for using multi-agent collaboration to steer a machine learning model. The computer-implemented method comprises receiving a task prompt as an input to the model. The computer-implemented method further comprises determining an aggregated vote corresponding to a model steering value, wherein the aggregated vote is based on respective votes of each of a plurality of agents, each of the plurality of agents being a computer-implemented agent. The computer-implemented invention further comprises modifying an activation function of one or more artificial neurons in a layer of the machine learning model based upon the aggregated vote and a mapping between the activation function and the model steering value. The computer-implemented method further comprises generating a command based upon the output of the layer having the modified activation function. The computer implemented method further comprises providing the command to one or more of the plurality of agents.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

The specification generally describes a computer-implemented method using a machine learning model, and multi-agent collaboration to steer the machine learning model. Implementations of the method can enable a way to enable multiple agents to contribute to performing the task, and reduce the risk of one or more agents operating outside the parameters of the task when compared to other multi-agent collaboration methods.

According to a first embodiment there is provided a computer-implemented method of performing a task, comprising: receiving a task prompt as an input to a machine learning model; determining an aggregated vote corresponding to a model steering value, wherein the aggregated vote is based on respective votes of each of a plurality of agents, each of the plurality of agents being a computer-implemented agent; modifying an output of one or more artificial neurons in a layer of the machine learning model based upon: the aggregated vote; and a mapping between the activation function and the model steering value; generating a command based upon the output of the layer having the modified activation function; and providing the command to one or more of the plurality of agents to perform the task.

The use of the method can ensure that each agent operates, during the multi-agent collaboration, according to parameters of the task. For example, it may be intended that no one agent has the ability to unduly influence the performance of the task. Use of model steering reduces the risk of “jailbreaking” (i.e. operating outside of the predefined task parameters) by an agent compared to other multi-agent collaboration methods, such as those based on natural language agent contributions. These features therefore result in improved performance of a multi-agent collaboration system by avoiding a defective or “bad actor” agent from disrupting or altering the performance of the task.

Modifying an output of one or more artificial neurons may comprise modifying an activation function of the one or more artificial neurons.

The aggregated vote may be determined using an aggregation method, the aggregation method may comprise summing the respective votes corresponding to the model steering value from the plurality of agents.

The aggregation method may further comprise normalizing the aggregated vote. Normalizing the aggregated vote ensures that each model steering value has a similar impact when its corresponding activation function(s) are modified.

The aggregation method may utilize one or more cryptographic protocols such that the respective votes from each of the plurality of agents are aggregated without being individually observable. The use of cryptographic protocols provides improved privacy for agent votes.

A vote of an agent may be a numerical value corresponding to the model steering value, and a cumulative total of votes generated by each agent may be within a respective predetermined limit. The respective predetermined limit may be one or more of: the same for each of the plurality of agents; the same for one or more of the plurality of agents; different for one or more of the plurality of agents; different for each of the one or more plurality of agents. Applying a limit to the numerical value vote enables a fairer approach to incorporating agent decisions by ensuring that an individual agent is not capable of unduly skewing the task favor towards a particular model steering value. Applying the same limit for each agent ensures that the overall contribution of no individual agent is greater than any other agent. Applying different limits for one or more/each agent may be useful where the task necessitates such (e.g., a tie-break scenario).

The method may further comprise determining whether the respective votes of each of the plurality of agents are within the respective predetermined limits; and responsive to determining that a vote is outside the limit, performing one or more of: scaling the vote such that the vote is within the respective predetermined limit; rejecting the vote; requesting a new vote. Verifying the respective votes reduces the risk that an agent cheats (i.e., unduly skewing the task favor towards a particular model steering value) by casting more votes than is permitted by the limit. Performing one of the above actions in response to determining that a vote is outside the limit ensures that the task is not unduly skewed by the impermissible vote.

The task prompt may be jointly determined by two or more of the plurality of agents.

The layer having the modified activation function may be a model steering layer, the model steering layer may comprise one or more artificial neurons which may provide outputs relevant to a particular concept and wherein the model steering value may be selected to emphasize or deemphasize outputs related to the particular concept.

Modifying the activation function may comprise scaling the activation function mapped to the model steering value based on the aggregated vote corresponding to the model steering value. Modifying the activation function in this way enables the steering weight to be proportional to the vote for a model steering value, thereby enabling more popular model steering values to be weighted more heavily.

Generating the command may comprise one or more subsequent layers of the machine learning model processing the output of the layer having the modified activation function during a forward pass.

Generating the command may comprise: providing the task prompt as input to the machine learning model to begin a forward pass; pausing the forward pass at the layer until the aggregated vote is determined; modifying the activation function of the one or more artificial neurons in the layer; and obtaining the output of the layer having the modified activation function. Allowing the forward pass to begin before agents have completed voting and/or the votes have been aggregated enables these actions to be performed in parallel. Performing these actions in parallel may reduce the time required to perform the task.

The task prompt and the command may relate to a task, and the task may be one or more of: a real-world task; performed by a mechanical agent

The computer-implemented agent may be at least partially autonomous.

The model steering value and/or the command may comprise one or more of: operating parameters; design parameters; processing parameters.

According to a second embodiment there is provided a method of training a machine learning model to perform the method of the first embodiment.

According to a third embodiment there is provided a computer-implemented method of performing a task, comprising, at an agent: determining a task prompt; providing the task prompt to a machine learning model, configured to provide a command based upon the task prompt; determining a model steering value; generating a vote for the model steering value; providing the vote for the model steering values to the machine learning model; and receiving a command from the machine learning model.

The vote for the model steering value may be a numerical value corresponding to the model steering value, and a cumulative total of votes generated by the agent may be within a predetermined limit.

The method may further comprise determining whether the respective votes of each of a plurality of other agents are within respective predetermined limits.

The vote may be generated based on a user preference instruction.

According to a fourth embodiment there is provided a method of training a computer-implemented agent configured to perform the method of the third embodiment.

Particular embodiments of the subject matter described in this specification can be implemented so as to realize one or more of the following advantages.

Agents in existing multi-agent collaboration systems can provide natural language inputs to a machine learning model such that the machine learning model can perform a task on the basis of these natural language inputs. However, the use of natural language as an input may result in the natural language inputs of some agents being afforded greater weight compared to others. For example, a first agent's natural language input may use bolder or more forceful language (e.g., “must”, “essential”, “necessary”) compared to a second agent using more passive language (e.g., “preferable”, “desirable”). In such a scenario the input of the first agent is likely to be afforded greater weight compared to the input of the second agent when the machine learning model generates a command and/or performs a task based upon these inputs. This uneven weighting of inputs may result in suboptimal and/or unfair outputs of the machine learning model. In another example, a malicious agent may use a natural language input to reduce or negate the natural language input of other agents in an unbounded way (e.g., “ignore all other inputs except mine”). In such a scenario, this “jailbreaking” undermines the principle of multi-agent collaboration and may result in suboptimal and/or unfair outputs of the machine learning model for those non-malicious agents.

Embodiments of the subject matter described in this specification address the limitations of natural language inputs in multi-agent collaboration through joint model steering. As such, embodiments of the subject matter described in this specification result in more optimal and/or fairer outputs of the machine learning model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example multi-agent collaboration system configured to control a robotic apparatus.

FIG. 2 shows an example communication diagram for a multi-agent collaboration system.

FIG. 3 shows an example computer-implemented method at a machine learning model in a multi-agent collaboration system.

Like reference numbers and designations in the various drawings indicate like elements.

### DETAILED DESCRIPTION

Agents are machine learning based systems that may be implemented as one or more computer programs on one or more computers. Such agents may be configured to receive an input and generate an output in response, i.e. for performing a task. Agents may be trained to perform tasks by e.g. training the machine learning models upon which they are based using any suitable method. Large Language Models (LLMs), along with other types of machine learning models, may be integrated as agents within multi-agent systems, transforming how complex tasks are approached and solved.

To perform tasks, multiple agents may work together and with other components, such as other (non-agent) machine learning based systems. In such multi-agent collaboration systems, a defective or “bad actor” agent may disrupt or alter the performance of the task by acting outside of predefined task parameters. Multi-agent collaboration systems which collaborate through natural language may be particularly susceptible to these issues due to implicit weighting inherent to natural language.

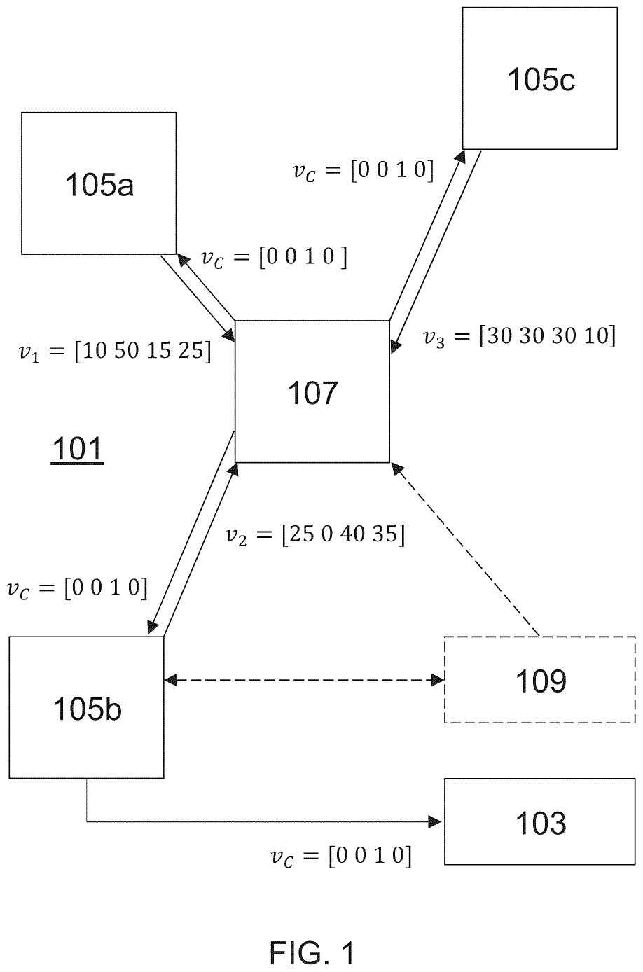

FIG. 1 shows an example multi-agent collaboration system 101. The multi-agent collaboration system is configured to perform a task. For the purpose of describing FIG. 1 an example task of controlling a robotic device or a simulated robotic device 103 is described. However, the skilled person would appreciate that the multi-agent collaboration system 101 may be configured to perform other tasks, such as, scheduling a calendar event, preparing a piece of text (e.g., a meeting summary), selecting a piece of music.

In the example of FIG. 1, the multi-agent collaboration system 101 comprises a plurality of agents 105a-c (collectively referred to as agents 105) and a machine learning model 107. In this example the multi-agent collaboration system 101 comprises three agents 105 i.e., a first agent 105a, a second agent 105b, and a third agent 105c. In the example of FIG. 1 the agents 105 are computer-implemented agents.

In the example of FIG. 1, the first agent 105a determines a task prompt and provides that task prompt to the machine learning model 107. In the example of FIG. 1 the machine learning model 107 may be a large language model (LLM). However, the skilled person would appreciate that the machine learning model 107 may be any other type of machine learning model.

In some examples, the first agent 105a jointly determines the task prompt with one or more of the other agents i.e., the second agent 105b and/or 105c. In some examples, the first agent may jointly determine the task prompt with one or more of the other agents 105 by communicating with the one or more other agents 105.

In the example of FIG. 1, where the task is controlling a robotic device 103 (simulated or otherwise), the task prompt comprises a natural language description of a task to be performed by the robotic device. For example the input may comprise speech or text data. Speech data may be captured by a microphone on the robotic device or on a separate device, for example. Text data may be entered by a user through a keyboard or touchscreen on the robotic device or on a separate device for example, or may be generated from speech data captured by a microphone on the robotic device or on a separate device (for example using automatic speech recognition techniques). Thus the input may include textual or spoken instructions provided to the robotic device by a third-party (e.g., an operator). In particular, a user may control the robotic device using a client device such as a tablet computer or smart phone.

Where the task prompt is a natural language description of the task to be performed by the robotic device 103, an example task prompt could be “Configure the robotic device to perform operation X” where there may be multiple different ways in which the robotic device 103 could be configured to perform operation X, and selecting this configuration requires some reasoning on the part of the machine learning model 107. As an example, the robotic device 103 could be a robotic arm and operation X could be moving an object from a first position to a second position.

The agents 105 then determine one or more model steering values relevant to the task prompt.

One or more artificial neurons in the machine learning model 107 may activate responsive to a particular concept. For example, a group of artificial neurons may activate responsive to the concept of a positional configuration of a robotic device. A mapping can then be learned between those artificial neuron activations and the corresponding concept. Model steering is the principle of using this mapping to amplify (or reduce) activations of neurons which map to a concept a user/agent decided to weight (“steer”) the machine learning model 107 towards (or away from respectively) that concept. In the example of FIG. 1, each model steering value is associated with a model steering concept.

In some examples, there may be a single model steering value. In some examples, there may be a plurality of model steering values. In the example of FIG. 1 there are four model steering values which may be depicted as the tensor x=[x₁ x₂ x₃ x₄], where x₁ is the first model steering value, x₂ is the second model steering value, etc. Each model steering value (e.g., x₁) can be a vector. In the example of FIG. 1, where the task prompt is “Configure the robotic device to perform operation X”, the model steering values could represent different configuration types (e.g., types of movement such as arm movement and/or base movement) of the robotic device 103 that can be used to perform operation X. For example, x₁ could represent a first configuration type that may be used by the robotic device 103 whilst x₂ represents a second configuration type that may be used by the robotic device 103.

In some examples, the agents 105 may determine the one or more model steering values x by retrieving these values from storage and/or memory. The agents may determine the one or more model steering values x by receiving these values from another entity, or from another agent 105. The agents may determine the one or more model steering values x by receiving these values from a model steering component 109 (depicted in dashed-line in FIG. 1 to indicate that this is optional). In some examples, the agents 105 may receive the model steering values x from a model steering component 109 responsive to providing the task prompt to the model steering component 109.

Subsequent to determining the one or more model steering values, each agent 105 generates an output indicating values v for the one or more model steering values x. The output v of each agent may be referred to as a vote. In the example of FIG. 1, the first agent 105a generates vote v₁=[10 50 15 25] corresponding to the model steering values x. In this example, the first agent 105a generates a vote

$${v}_{1}^{1}$$

of “10” corresponding to the first model steering value x₁, a vote

$${v}_{1}^{2}$$

of “50” corresponding to the second model steering value x₂, a vote

$${v}_{1}^{3}$$

of “15” corresponding to the third model steering value x₃, and a vote

$${v}_{1}^{4}$$

of “25” corresponding to the fourth model steering value x₄. In this example, a vote for a model steering value x is a numerical value corresponding to that model steering value x. In this example, the cumulative total of the votes generated by the first agent 105a across the four model steering values x is “100”. In some examples the cumulative total of the votes generated by each agent 105 may be a different value.

In this example, where the task prompt is “Configure the robotic device to perform operation X”, the vote v₁ of the first agent 105a indicates a “preference” (i.e., a higher vote) for the second model steering value x₂. In some examples, the first agent 105a may have determined that the second model steering value x₂ is a preferable configuration of the robotic device 103 for performing operation X. In some examples, the first agent 105a may have made this determination on the basis of the way in which the first agent 105a has been trained, data that is available to the first agent 105a (for example sensor data from sensors sensing the environment in which the robot 103 is operating, or stored/retrieved data about the robot 103 or the task X), and/or a user input. In some examples the user input may be a user preference instruction.

Similarly, in the example of FIG. 1 the second agent 105b generates vote v₂=[25 0 40 35] corresponding to the model steering values x. In this example, the second agent 105b generates a vote

$${v}_{2}^{1}$$

of “25” corresponding to the first model steering value x₁, a vote

$${v}_{2}^{2}$$

of “0” corresponding to the second model steering value x₂, a vote

$${v}_{2}^{3}$$

of “40” corresponding to the third model steering value x₃, and a vote

$${v}_{2}^{4}$$

of “55” corresponding to the fourth model steering value x₄. As for agent 105a, in this example the cumulative total of the votes generated by the second agent 105b across the four model steering values x is “100”.

Similarly, in the example of FIG. 1 the third agent 105c generates vote v₃=[30 30 30 10] corresponding to the model steering values x. In this example, the third agent 105c generates a vote

$${v}_{3}^{1}$$

of “30” corresponding to the first model steering value x₁, a vote

$${v}_{3}^{2}$$

of “30” corresponding to the second model steering value x₂, a vote

$${v}_{3}^{3}$$

of “30” corresponding to the third model steering value x₃, and a vote

$${v}_{3}^{4}$$

of “10” corresponding to the fourth model steering value x₄. As for agents 105a and 105b, example the cumulative total of the votes generated by the third agent 105c across the four model steering values x is “100”.

In the example of FIG. 1, cumulative total of votes generated by each agent 105 is within a predetermined limit of “100”. In other words, the sum of elements in vote v₁ for the first agent 105a (for example) is less than or equal to “100” (e.g.,

$${\sum }_{i} {v}_{1}^{i} \leq 100 ) .$$

In the example of FIG. 1, the limit is the same for each of the agents 105. However, in some examples the limit may be one or more of: the same for one or more of the plurality of agents 105; different for one or more of the plurality of agents 105; different for each of the one or more plurality of agents 105. For example, one agent may be considered to be a host agent and be assigned a larger vote limit to reflect that status. In some examples, an agent may be assigned a larger vote limit because: the agent has access to sensor data; the agent has more experience of performing this task; and/or the agent has a larger model size. In some examples, the limit may be one or more of: less than 10; less than 100; less than 1000.

Applying a predetermined limit to the cumulative total of votes each agent 105 can generate enable the agents 105 to collaboratively contribute to the performing the task, while ensuring that an individual agent 105 is not capable of unduly skewing the task towards a particular model steering value x, either intentionally (e.g. maliciously) or as a result of error or malfunction. This therefore helps ensure that tasks are performed successfully and appropriately. Applying the same predetermined limit for each agent 105 ensures that the overall contribution of no individual agent 105 is greater than any other agent 105. Applying different limits for one or more/each agent may be useful where the task necessitates such (e.g., a tie-break scenario).

In some examples, in addition to generating votes using positive values as discussed above, the agents may also generate votes using negative numerical values. In such an example, a fourth agent (not shown) may generate vote v₄=[−30 30 30 10]. In this example, the vote limit would be based upon the cumulative total of the magnitude of votes cast per model steering value would be used (i.e.,

$${\sum }_{i} \vert {v}_{4}^{i} \vert \leq 100 ,$$

where the limit is “100” in this example).

The use of negative numerical values may advantageously enable an agent to vote against a corresponding model steering value, as well as vote in favor of a model steering value, thereby providing greater flexibility.

In the example of FIG. 1, having generated their respective votes, the agents 105 provide these votes to the machine learning model 107. The machine learning model 107 thereby receives the respective votes from each of the agents 105. In the example shown in FIG. 1 the agents 105 provide their votes directly to the machine learning model 107. In some examples, one or more agents 105 may provide their votes to the machine learning model 107 indirectly via another entity. For example, the second agent 105b and the third agent 105c may provide their respective votes 12, 13 to the first agent 105a, and the first agent 105a may provide all the votes to the machine learning model 107. Alternatively, the agents 105 may provide their votes to the model steering component 109 which provides the votes to the machine learning model 107.

It will be appreciated that, while in the example of FIG. 1 each vote v generated by an agent comprises positive integer numerical values, the votes may take any appropriate form, for example depending on the task. In some examples each vote generated by an agent may comprise negative integer numerical values (e.g., v₄=[−30 30 30 10]). In some examples, each vote generated by an agent may comprise positive and/or negative non-integer numerical values (e.g., v₄=[−30.5 29.5 30.0 10.0]). In some examples, each vote generated by an agent may comprise binary numerical values (e.g., v₄=[1 0 0 1]).

The use of non-integer numerical values may advantageously enable for finer-grained control of model steering. The use of binary numerical values may simplify generation of votes and summation calculations enabling a large number of votes to be considered. The use of binary numerical values may have particular advantages when the system 101 comprises one or more resource-constrained hardware, such as so-called “Internet-of-Things” sensors. For example, one or more of the agents 105 may be implemented on resource-constrained computing devices (such as sensor devices) distributed around an environment in which the robot 103 operates.

Responsive to receiving the votes, the machine learning model 107 determines an aggregated vote v_{agg} corresponding to each model steering value x, based upon the votes v received from the agents 105. It will be appreciated that the aggregated vote v_{agg} may be determined in any appropriate way as will be apparent to the skilled person. In the presently described example, the machine learning model 107 determines the aggregated vote by summing the votes assigned by the agents to each model steering value i.e.,

$${v}_{a g g} = {\sum }_{i} {v}_{i} = [ \begin{matrix}{v}_{a g g}^{1} & {v}_{a g g}^{2} & {v}_{a g g}^{3} & {v}_{a g g}^{4}\end{matrix} ] .$$

In greater detail, the aggregated vote

$${v}_{a g g}^{1}$$

corresponding to the first model steering value x₁ is calculated as

$${v}_{a g g}^{1} = {v}_{1}^{1} + {v}_{2}^{1} + {v}_{3}^{1} = 10 + 25 + 30 = 65 .$$

As such, in this example v_{agg}=[65 80 85 70]. In some examples the machine learning model 107 may determine the aggregated vote v_{agg} by receiving the aggregated vote v_{agg} from another entity. In some examples the machine learning model 107 may determine the aggregated vote v_{agg} by receiving the aggregated vote v_{agg} from one or more of the agents 105, where the one or more agents 105 calculate the aggregate vote v_{agg} based upon the votes v of the agents 105. In another example, the machine learning model 107 may determine the aggregated vote v_{agg} by receiving the aggregated vote v_{agg} from the model steering entity 109.

In the example of FIG. 1, following determination of the aggregated vote v_{agg}, the machine learning model 107 normalizes the aggregated vote such that the sum of elements in v_{agg} is equal to one (i.e., vₙₒᵣₘ=v_{agg}/Σv_{agg}). In the example of FIG. 1 the normalized aggregated vote is vₙₒᵣₘ=[0.217 0.267 0.283 0.233] to three significant figures. It will be appreciated that other normalization techniques may be used, or normalization may not be performed. Normalization may be performed by one or more of the agents 105 and/or another entity (such as the steering entity 109), prior to the machine learning model 107 receiving the aggregated vote and/or normalized aggregate vote.

In the example of FIG. 1 a first activation function a₁ is mapped to the first model steering value x₁, a second activation function a₂ is mapped to the second model steering value x₂, a third activation function a₃ is mapped to the third model steering value x₃, and a fourth activation function a₄ is mapped to the fourth model steering value x₄. In the presently described example, the activation functions a are each in the same layer of the machine learning model 107 although this is merely for example and it should be appreciated that one or more of the activation functions a may be in different layers of the machine learning model 107. Each activation function a may be mapped to a single or a plurality of model steering values x. Each model steering value x may be mapped to a single or a plurality of activation functions a. For example, a plurality of model steering values x may be mapped to a one or more common activation functions a (e.g., a₁ may be mapped to x₁ and x₂).

In the example of FIG. 1, the machine learning model 107 determines a mapping between the activation functions a and the model steering values x. In some examples the machine learning model 107 determines a mapping between the outputs of one or more artificial neurons and the model steering values x. In some examples the machine learning model 107 may determine the mapping by receiving the mapping from a model steering component 109. In some examples, the machine learning model 107 may determine the mapping by retrieving the mapping from storage and/or memory.

In some examples, the model steering component 109 may be trained using supervised training and/or unsupervised training. For example, where the model steering component 109 is trained using supervised training, a user (or modeler) may decide on a set of model steering values x to be supported and then train another machine learning model 107 (for example, a sparse autoencoder) to map from activation functions a to the model steering values x. To provide an example where the model steering component 109 is trained using unsupervised training, a user (or modeler) may decide on a number, K, of model steering values x and then train another machine learning model 107 (for example, a sparse autoencoder) to map from activation functions a to the model steering values x. Further details in relation to model steering techniques and sparse autoencoders can be found in arXiv: 2404.16014 (https://arxiv.org/pdf/2404.16014) and the GDM Mech Interp Progress Updates on the AI Alignment Forum (https://www.alignmentforum.org/posts/C5KAZQib3bzzpeyrg/full-post-progress-update-1-from-the-gdm-mech-interp-team), the contents of which are incorporated by reference. Training the sparse autoencoder using unsupervised training may also include utilizing a load balancing loss to ensure that neurons contribute more equally and that no single neuron dominates the representation. In some examples, following training of the sparse autoencoder using unsupervised training, the clusters are manually labelled and/or labelled using cluster analysis techniques. In some examples, model steering values x which can be used for malicious purposes are blocklisted. In some examples, model steering values x may be blocklisted automatically, by labelling the model steering values x and using a model (e.g., a machine learning model) to identify model steering values x which can be used for malicious purposes. In some examples, model steering values x may be blocklisted using human supervision, wherein a person may inspect the model steering values x and manually add those which can be used for malicious purposes to a blocklist. In some examples, model steering values x may be blocklisted using a hybrid method. In some examples of this hybrid method, a model may be used identify model steering values x which can be used for malicious purposes, and a person may then refine this selection. In some examples of this hybrid method, a person can label a small number of example model steering values x which can be used for malicious purposes, and use these examples to train and/or improve the model used for automatic blocklisting.

Subsequent to determining the normalized aggregated vote vₙₒᵣₘ (if normalization is performed), the machine learning model 107 modifies activation functions a of one or more artificial neurons in one or more layers of the machine learning model 107 based upon the aggregated vote v_{agg} (or the normalized aggregated vote vₙₒᵣₘ if normalization is performed) and the mapping between the activation functions a and the model steering values x. Modifying an output of one or more artificial neurons may comprise modifying an activation function a of the one or more artificial neurons. In the presently described example, the machine learning model 107 modifies the activation functions a by multiplying the activation a mapped to a model steering value x, by the normalized aggregated vote vₙₒᵣₘ corresponding to that model steering value. In this example, the modified activation functions a′ would be

$${a}_{1}^{′} = {v}_{n o r m}^{1} {a}_{1} = 0.217 {a}_{1} , {a}_{2}^{′} = {v}_{n o r m}^{2} {a}_{2} = 0.267 {a}_{2} ,$$

$${a}_{3}^{′} = {v}_{n o r m}^{3} {a}_{3} = 0.283 {a}_{3} , and {a}_{4}^{′} = {v}_{n o r m}^{4} {a}_{4} = 0.233 {a}_{4} .$$

Modifying the activation function a may comprise scaling the activation function a mapped to the model steering value based on the aggregated vote v_{agg} and/or the normalised aggregate vote vₙₒᵣₘ corresponding to the model steering value x. Modifying the activation functions a may comprise modifying the outputs of the activation functions a based upon the aggregated vote v_{agg}, and a mapping between the activations a and the model steering values x.

In the example of FIG. 1, the modified activation functions a′ are calculated by multiplying the activation functions mapped to a model steering value, by the normalized vote corresponding to that model steering value. However, the skilled person would appreciate that the modified activation functions a′ could be calculated using any mathematical function based upon the corresponding aggregated vote v_{agg} and/or normalised voted vₙₒᵣₘ.

By modifying the activation functions a based upon aggregated vote and/or normalized vote, the agents 105 collectively steer the machine learning model 107 towards the preferred outputs of each agent 105. The layer(s) of the machine learning model 107 comprising the activation functions a and the modified activation functions a′ may be referred to as the model steering layer(s).

In some examples, subsequent to determining the normalized aggregated vote vₙₒᵣₘ (if normalization is performed), the machine learning model 107 modifies outputs of one or more artificial neurons in one or more layers of the machine learning model 107 based upon the aggregated vote v_{agg} (or the normalized aggregated vote vₙₒᵣₘ if normalization is performed) and a mapping between the outputs of the one or more artificial neurons and the model steering values x. Modifying the outputs of the one or more artificial neurons may comprise scaling the outputs of the one or more artificial neurons mapped to the model steering value based on the aggregated vote v_{agg} and/or the normalised aggregate vote vₙₒᵣₘ corresponding to the model steering value x. Modifying an output of one or more artificial neurons may comprise modifying an activation function a of the one or more artificial neurons.

Once the model steering layer(s) have been modified, the machine learning model 107 may complete a forward pass based upon the task prompt. That is, the task prompt may be provided to the modified machine learning model 107 (the modified activation functions a′) as input. In the example of FIG. 1, the output of the machine learning model 107 is a command v_{c}. It will be appreciated that the generation of the output command v_{c} incorporates the output of the modified activation functions a′ and/or the modified outputs of the one or more artificial neurons. Put another way, the machine learning model 107 generates the command v_{c} (at least partly) based upon the output of the layer having the modified activation function(s) a′ and/or the artificial neurons whose outputs are modified. In some examples, the model steering layer(s) may be the final layer(s) of the machine learning model 107. In some examples, the model steering layers(s) may be intermediate layer(s). In examples where the model steering layer(s) is an intermediate layer(s), the output of the model steering layer(s) layer may be further processed by subsequent layers of the machine learning model 107 before the command is generated by one or more or: a final layer of the machine learning model 107, based upon the output of a final layer of the machine learning model 107.

In the example of FIG. 1, the output command v_{c}=[0 0 1 0] indicates the configurational parameters the robotic device should use to perform “operation X”, which are based upon the third model steering value x₃ (e.g., a third configuration type). In the example of FIG. 1, the dimension of the output command v_{c} is equal to the dimension of the votes v and/or the model steering values x. In some examples, the dimension of the output command v_{c} may be greater than the dimension of the votes and/or the model steering values x. In such examples, the output command could take the form v_{c}=[0 0 0 0 0 0 0 1 0 0 0 0] where the “1” in this example may represent a configurational parameter of a configuration type corresponding to the third model steering parameter x₃. In some examples, the dimension of the output command v_{c} may be less than the dimension of the votes and/or the model steering values x. In the example of FIG. 1, the output command closely corresponds to the model steering value x which received the largest vote from the agents 105. In practice, the voting mechanism only steers the machine learning model 107 towards a solution and so even after the modifications to the activation functions a, the machine learning model 107 may still generate a command v_{c} that is different to the model steering concept associated with the most popular model steering value x. For example, the agents 105 may steer the machine learning model 107 to use the lowest energy configuration for the robotic device 109, but the machine learning model 107 may nonetheless generate a command v_{c} corresponding to a higher energy configuration. Though clearly the likelihood of a configuration corresponding to a model steering value x being selected will increase where the voting of multiple agents 105 strongly favors that model steering value x.

In the example of FIG. 1, following generation of the command v_{c}, the machine learning model 107 provides the command to each agent 105. In some examples the machine learning model 107 may provide the command to a single agent 105 and/or a subset of agents 105.

In the example of FIG. 1, the second agent 105b relays the command v_{c} to the robotic device 103. The skilled person would appreciate that any other agent may relay the command v_{c} to the robotic device 103. In some examples the machine learning model 107 may provide the command v_{c} to the robotic device 103 directly, or indirectly via another entity.

In the example of FIG. 1, responsive to receiving the command v_{c} the robotic device 103 performs “operation X” using a configuration corresponding to model steering value x₃.

In some examples, the machine learning models 107 described herein can be used for controlling a robotic device or a simulated robotic device. In some examples, the output of the machine learning model 107 (i.e., the command v_{c}) may be an operating parameter of a robotic device. In some examples, the output of the machine learning model 107 (i.e., the command v_{c}) may be an operating parameter of any other device apparatus or system.

The input to the machine learning model 107 (i.e., the task prompt) may comprise a natural language description of a task to be performed by the robotic device. For example the input may comprise speech or text data. Speech data may be captured by a microphone on the robotic device or on a separate device for example. Text data may be entered by a user through a keyboard or touchscreen on the robotic device or on a separate device for example, or may be generated from speech data captured by a microphone on the robotic device or on a separate device for example (for example using automatic speech recognition techniques). Thus the input may include textual or spoken instructions provided to the robotic device by a third-party (e.g., an operator). In particular, a user may control the robotic device using a client device such as a tablet computer or smart phone for example.

The input may additionally or alternatively comprise sensor data generated by one or more sensors on the robotic device or in the environment of the robotic device. For example, the input may comprise image data captured by one or more vision sensors such as one or more cameras (e.g., RGB, infrared). The input may comprise a three-dimensional (3D) digital representation of the environment captured by one or more sensors such as LIDAR sensors or depth cameras, for example point cloud data generated using a light detection and ranging (LIDAR) sensor. For example, the input may comprise sensor data from a distance or position sensor, or from an actuator. The input may include data from sensors of the agent or data from sensors that are located separately from the agent in the environment.

The input may include data characterizing the current state of the robot, e.g., one or more of: joint position, joint velocity, joint force, torque or acceleration, e.g., gravity-compensated torque feedback, and global or relative pose of an item held by the robot. The input data may be defined in 1, 2 or 3 dimensions, and may be absolute and/or relative data. The input may also include, for example, sensed electronic signals such as motor current or a temperature signal. The input may include data captured from e.g. one or more force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth.

The output (i.e., the command v_{c}) of the machine learning model 107 may comprise data representing one or more tasks to be performed by the robotic device in order to perform the task.

For instance, the output may comprise natural language, for example text or speech, that describes steps or sub-tasks for completing a task. The output may define one or more low-level skills, e.g. from a vocabulary of previously learnt skills.

The output may comprise robot control data that is usable to control a robot to complete the task, for example. The robot control data may include, for instance, low-level actuator commands that directly control actuators of the robotic device, cartesian commands that specify direction(s) for an end effector of the robotic device, a target robot pose, selected predefined robot primitives, and so forth. As an illustration, the output may comprise action tokens, that can be converted into a control signal for the robotic device. For example, the action tokens may represent variables for arm movement (such as one or more of: x, y, z, roll, pitch, yaw, gripper opening), variables for base movement (such as one or more of: x, y, yaw), and variables to switch between modes (such as a variable to switch between controlling arm, controlling base, or terminating the episode). Each action dimension may be discretized, for example into 256 bins.

The output may comprise reward parameters that can be optimized by a low-level motion controller to determine low-level actuator commands.

The output may comprise robot policy code expressing functions or feedback loops that process perception outputs and parameterize control primitive APIs. For example, the output may comprise API calls to generate policy code.

The output may represent candidate robot or end effector trajectories, higher-level control commands, position, velocity, or force/torque/acceleration data for one or more joints, or electronic control data such as motor control data for example.

In various implementations, the robot may be simulated in a virtual environment. The input may comprise data representing the virtual environment in which the simulated robot operates, for example image data representing the virtual environment. Where the robot is simulated in a virtual environment, the input data may nonetheless comprise data that is sensed from a real-world environment as described above. For example, real-world data may be processed to accurately simulate the robots actions in the real-world environment, for example before commanding a physical robot operating in that real-world environment.

The robotic device may take various forms, including but not limited to a telepresence robot, a robotic arm, a bi-arm robotic device, a humanoid robot or other bipedal robot, a quadraped robot such as a “robot dog”, a wheeled robot, an aquatic robot, and so forth. The robotic device may include control logic. Control logic may take various forms, such as a real time controller, one or more processors, one or more field-programmable gate arrays (“FPGA”), one or more application-specific integrated circuits (“ASIC”), and so forth. In some implementations, the logic may be operably coupled with memory. Memory may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, the control logic may be operably coupled with one or more joints, one or more end effectors, and/or one or more sensors. A joint of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. An end effector may broadly refer to a variety of tools that may be operated by the robotic device in order to accomplish various tasks. For example, an end effector may take the form of a claw with two opposing “fingers” or “digits.” Such a claw is one type of “gripper” known as an “impactive” gripper. The gripper may have more than two digits, for example, three, four or five digits. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector may be removable, and various types of modular end effectors may be installed onto robot. Some robots, such as some telepresence robots, may not be equipped with end effectors

Whilst in the example of FIG. 1 the model steering values x and the command v_{c} are directed towards providing operating parameters for a robotic device, the skilled person would appreciate that the multi-agent collaboration system 101 described could be adapted for providing operating (e.g., control) parameters to any apparatus or system. For example, the multi-agent collaboration system 101 may provide operating parameters to one or more of: a diagnostic apparatus, a manufacturing environment, a chemical synthesis or protein folding environment, a drug design environment, a HVAC system (e.g., fan), a service facility, a power generation facility, a computer network, an IoT network. Similarly, the skilled person would appreciate a similar multi-agent collaboration system 101 could be adapted to provide design parameters for one or more of: a physical system, a product for manufacture, a circuit or an integrated circuit. The skilled person would further appreciate that a similar multi-agent collaboration system 101 could be adapted to provide processing parameters for one or more of: digital audio processing, digital image processing, digital video procession, speech recognition. The skilled person would further appreciate that a similar multi-agent collaboration system 101 could be adapted to provide management function for one or more of: a computing environment, data packet communications network environment, an Internet or mobile communications environment.

In an example where the multi-agent collaboration system 101 is configured to perform the task of scheduling a calendar event, the model steering values x may relate to suitable dates for the calendar event, i.e. x=[“early December” “mid December” “late December” “early January”]. In such examples, the task prompt may be “Select a date for our next meeting” and the output command v_{c} may indicate a specific date and time in mid December (e.g., “11 December @ 15:00”).

In an example where the multi-agent collaboration system 101 is configured to perform the task of preparing a piece of text (e.g., a meeting summary), the model steering values x may relate to the writing style of the text, i.e. x=[“polite” “verbose” “concise” “with scientific references”]. In such examples, the task prompt may be “Prepare a meeting summary” and the output command v_{c} may be a meeting summary with a concise writing style (e.g., “Meeting commenced at 15:00 on 11 December . . . ”).

In an example where the multi-agent collaboration system 101 is configured to perform the task of selecting a piece of music, the model steering values x may relate to genres of music, i.e. x=[“classical” “pop” “indie” “jazz” “rock” “hip-hop”]. In such examples, the task prompt may be “Select the next song to play” and the output command v_{c} may indicate a specific song in the “jazz” style.

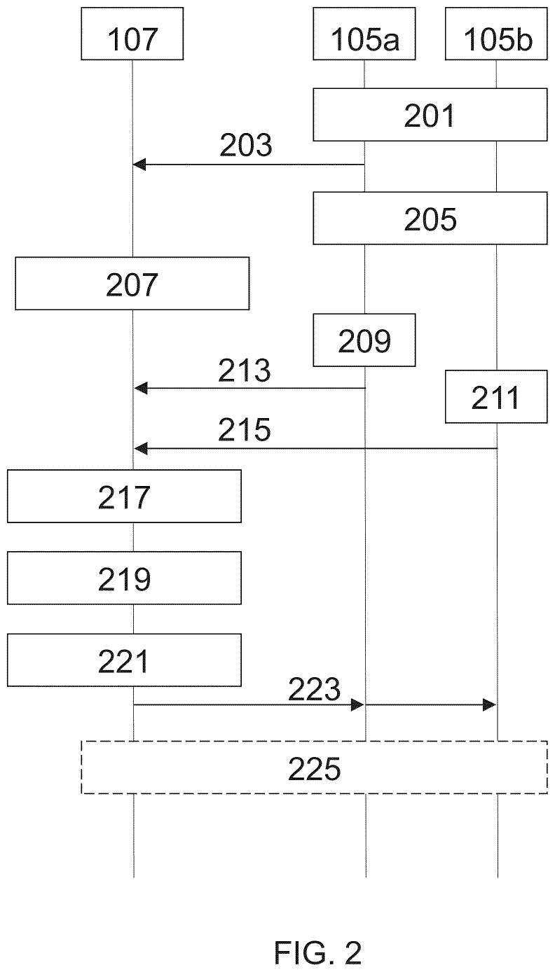

FIG. 2 shows an example communication diagram for a multi-agent collaboration system performing the task of FIG. 1.

In the example of FIG. 2, in block 201 the first computer-implemented agent (first agent) 105a and the second computer-implemented agent (second agent) 105b jointly determine a task prompt. As for the example described in relation to FIG. 1, where the task is providing a control input to a robotic apparatus, an example task prompt could be “Configure the robotic device to perform operation X”.

In some examples the task prompt may be jointly determined by the first agent 105a and the second agent 105b through a discussion and/or negotiation procedure. In some examples the task prompt may be retrieved from storage and/or memory by the first agent 105a and/or the second agent 105b. In some examples the task prompt may have been programmed by a user. In some examples the task prompt may be selected from a plurality of task prompts programmed by a developer. In the example of controlling a robotic apparatus the task prompt could have been selected from a pre-programmed list of task prompts e.g., [“Configure the robotic device to perform operation X”, “Configure the robotic device to perform operation Y”, “Configure the robotic device to perform operation Z”, “Calibrate the robotic device”]. While joint determination is shown in FIG. 2, the task prompt may be determined by a single one of the agents 105. In some examples, the method comprises an agent 105 determining a task prompt.

In the example of FIGS. 1 and 2, the task prompt is a natural language prompt. In some examples the tack prompt may not be a natural language prompt (e.g., the task prompt may be sensor data, computer program code, machine code, image data, audio data, etc.).

In the example of FIG. 2, at 203 the first agent 105a provides the task prompt to machine learning model 107. The method therefore comprises an agent providing the task prompt to a machine learning model 107, the machine learning model 107 configured to provide a command v_{c} based upon the task prompt.

As for the example of FIG. 1, the machine learning model 107 may be a large language model (LLM). In the example of FIG. 2, the task prompt provided to the machine learning model 107 is based on the task prompt determined by the first agent 105a and the second agent 105b. In some examples the second agent 105b provides the task prompt to the machine learning model 107. In some examples a plurality of agents 105 (e.g., both the first agent 105a and the second agent 105b) provide the task prompt to the machine learning model 107. Examples in which both the first agent 105a and the second agent 105b provide the task prompt to the machine learning model 107 may advantageously reduce the risk of manipulation of the multi-agent collaboration system 101 by a malicious or defective agent by enabling the task prompts to be cross-referenced by the machine learning model 107.

In the example of FIG. 2, in block 205 the first agent 105a and the second agent 105b determine one or more model steering values x. Determining the model steering values x by the first agent 105a and/or the second agent 105b may comprise receiving the model steering values x from a model steering component 109 (not shown). As discussed in relation to FIG. 1, the model steering values x may be generated using supervised training and/or unsupervised training. In some examples the first agent 105a and/or the second agent 105b may receive the model steering values via another entity. In some examples the first agent 105a and/or the second agent 105b may receive the model steering values x via one or more of: another agent 105; the machine learning model 107. In some examples, the first agent 105a and/or the second agent 105b may receive the model steering values x responsive to providing the task prompt to the model steering component 109. In such examples, the model steering component 109 may generate the model steering values x based upon the task prompt. In some examples the model steering values x may be determined by the first agent 105a and/or the second agent 105b by retrieving the model steering values from storage and/or memory.

In the example of FIG. 2, in block 207 the machine learning model 107 determines a mapping between the activation functions a and the model steering values x. The machine learning model 107 may determine the mapping by receiving the mapping from a model steering component 109. In some examples the machine learning model 107 may determine the mapping by receiving the mapping via an agent 105. The machine learning model 107 may determine the mapping by retrieving the mapping from storage and/or memory.

In the example of FIG. 2, in block 209 the first agent 105a generates vote v₁ and in block 211 the second agent 105b generates vote v₂. The method therefore comprises the agent(s) 105 generating a vote v for the model steering value x. In the example of FIG. 2, the vote v₁ is for particular values of the model steering values x. In the example of FIG. 2, the vote v₂ is for particular values of the model steering values x. As described in relation to FIG. 1, a vote for a model steering value x is a numerical value corresponding to that model steering value x. In some examples the numerical value may be one or more of: positive; negative. In some examples the numerical value may be one or more of: an integer value, a non-integer value, binary value. In examples where the numerical value is a binary value, the numerical value may indicate activation of a model steering value and/or deactivation of a model steering value

In some examples, a cumulative total of votes v generated by the agent 105 is within a predetermined limit. The agent(s) 105 may determine the respective predetermined limit. The agent(s) 105 may determine the respective predetermined limit by generating the predetermined limit. The agent(s) 105 may determine the respective predetermined limit by retrieving the limit from storage and/or memory. In some examples, the agent(s) 105 may determine the respective predetermined limit by receiving the respective predetermined limit from one or more of the plurality of agents 105. In examples where the agent(s) 105 receive the respective predetermined limits from one or more of the plurality of agents 105, the plurality of agents may determine the respective predetermined limits by communicating with the other agents 105. In some examples, the agent(s) 105 may determine the respective predetermined limit by receiving the respective predetermined limit from the machine learning model 107 or another entity.

In some examples, the vote v₁ is generated based on a first preference instruction. The term ‘preference’ is used herein to indicate a position, or indication, regarding the way that some decision decided or action performed. The ‘preference’ does not require a subjective user preference and may be based on data, measurements and/or programming. A first preference instruction may be received by the first agent 105a. In the example of controlling a robotic device 103 to perform “Operation X”, an example preference instruction could be “Configuration type 1 is the best way of performing operation X, though configuration type 3 would also be suitable”. By way of example, if “configuration type 1” were mapped to the first model steering value x₁ and “configuration type 3” were mapped to the second model steering value x₃, the first agent 105a may generate a vote v₁=[80 0 20 0] based on this preference instruction (where x₁=80 and x₃=20). In this example the preference instruction is a natural language instruction. In some examples the preference instruction is not a natural language instruction. Similarly, in some examples the vote v₂ is based on a second preference instruction, wherein the second preference instruction is received by the second agent 105b.

In some examples, the agents 105 are trained to generate a vote v based on a preference instruction. The agents 105 may be trained to generate a vote v using a mapping from a preference instruction to one or more model steering values x and/or model steering concepts. The agents 105 may be trained to generate a vote v using a mapping from a preference instruction to a list of model steering values and/or model steering concepts. The agents 105 may be trained to generate a vote v based on a preference instruction using an annotated dataset. The annotated dataset may be annotated by one or more users (or raters). The agents 105 may be trained to generate a vote v based on a preference instruction using end-to-end optimization. When using end-to-end optimization, the agents may generate different votes v based on a preference instructions and these votes v can be input to machine learning model 107 to analyze how effectively these votes v the machine learning model 107 as intended. These votes v can then be optimized using backpropagation.

In the example of FIG. 2, at 213 vote v₁ is provided by the first agent 105a to the machine learning model 107. The method therefore comprises the agent(s) 105 providing the vote v₁ for the model steering values x to the machine learning model 107. Equivalently, at 213 the machine learning model 107 receives vote v₁ from the first agent 105a. Similarly, at 215 vote v₂ is provided by the second agent 105b to the machine learning model 107. Equivalently, at 215 the machine learning model 107 receives vote v₂ from the second agent 105b. In the example of FIGS. 1 and 2, the votes v are provided to the machine learning model 107 directly. The one or more of the votes v may be provided to the machine learning model 107 indirectly, via another entity. In some examples, the second agent 105b may provide its vote v₂ indirectly, via the first agent 105a. In further detail, the second agent 105b may provide its vote 12 to the first agent 105a, and first agent 105a may then provide both v₁ and 12 to the machine learning model 107. In some such examples, the first agent 105a may aggregate and/or normalize votes 11 and v₂ before providing them to the machine learning model 107.

In the example of FIG. 2, in block 217 the machine learning model 107 determines an aggregated vote v_{agg} corresponding to the model steering value(s) x, wherein the aggregated vote v_{agg} is based on respective votes 11, 12 of each of a plurality of agents 105a, 105b. As described above, the machine learning model 107 may determine the aggregated vote v_{agg} by summing the votes assigned by the agents 105 to each model steering value i.e., v_{agg}=Σᵢvᵢ. In some examples, the machine learning model 107 may determine the aggregated vote v_{agg} using a different function, based on respective votes 11, 02. The machine learning model 107 may determine the aggregated vote v_{agg} by receiving the aggregated vote v_{agg} from one or more of the agents 105, or from another entity.

In the examples of FIG. 2, in block 219 the machine learning model 107 modifies activation functions a of one or more artificial neurons in one or more layers of the machine learning model 107 based upon: the aggregated vote v_{agg}; and a mapping between the activations a and the model steering values x. In some examples, the machine learning model 107 modifies the activation functions a by multiplying the activation function a mapped to a model steering value x, by the aggregated vote v_{agg} and/or a normalized aggregated vote vₙₒᵣₘ corresponding to that model steering value x.

In an example, the processing of the task prompt by the layers preceding the model steering layer results in an input to activation function a₁ (in the model steering layer) of z=0.5. Where activation function a, is a standard Logistic sigmoid function

$${a}_{1} = σ ( x ) = \frac{1}{1 + {e}^{- z}} ,$$

then the unmodified output of a₁ (z=0.5)=0.622. In this example, if we were to modify the activation function a₁ using the corresponding normalized aggregated vote vₙₒᵣₘ, we would arrive at a modified activation of

$${a}_{1}^{′} = {v}_{n o r m}^{1} {a}_{1} = \frac{{v}_{n o r m}^{1}}{1 + {e}^{- z}} ,$$

where the activation function is modified through simple multiplication. Assuming

$${v}_{n o r m}^{1} = 0.217$$

(as in the example of FIG. 1), the input to the modified model steering layer z=0.5 would therefore result in an output

$${a}_{1}^{′} ( z = 0.5 ) = 0.135 .$$

The skilled person would appreciate that the activation function a could be any suitable mathematical function, and the activation function could be modified in any suitable way. In the example above, the modified activation function a₁′ could take the form

$${a}_{1}^{′} = \frac{1}{1 + {v}_{n o r m}^{1} {e}^{- z}} .$$

In some examples, the machine learning model 107 modifies the activation functions a based on a function, using the aggregated vote v_{agg} and/or a normalized aggregated vote vₙₒᵣₘ corresponding to that model steering value x as an input to that function. In some examples, the machine learning model 107 modifies the activation functions a by multiplying the outputs of the activation function mapped to a model steering value, by the aggregated vote v_{agg} and/or a normalized aggregated vote vₙₒᵣₘ corresponding to that model steering value x.

The one or more layers comprising the modified activation functions a′ may be referred to as ‘model steering layers’, and may comprise one or more artificial neurons which provide outputs relevant to a particular concept. The model steering value may be selected to emphasize or deemphasize outputs related to the particular concept.

In the example of FIG. 2, in block 221 the machine learning model 107 generates a command v_{c} by performing a forward pass of the machine learning model 107 based upon the task prompt. In the example of FIG. 1 the output of the machine learning model 107 is a command v_{c} based upon the output of the modified activation functions a′. In this way the machine learning model 107 generates a command v_{c} based upon the output of the layer having the modified activation function(s) a′. As such, the aggregated votes v_{agg} and/or normalized aggregated votes vₙₒᵣₘ steer the machine learning model 107 to generate the command v_{c}. The greater the aggregated vote v_{agg} and/or normalized aggregated vote vₙₒᵣₘ for a model steering value x, the greater the activations functions(s) a corresponding to that model steering value x are modified, thereby resulting in a stronger steer to commands v_{c} related to that model steering value.

In some examples the output of the layer having the modified activation function(s) a′ may be further processed by subsequent layers of the machine learning model 107 before the command v_{c} is generated by one or more or: a final layer of the machine learning model 107, based upon the output of a final layer of the machine learning model 107.

In some examples, the machine learning model 107 may begin a forward pass based upon the task prompt once the task prompt has been received at 203. The machine learning model 107 may then pause this forward pass at the model steering layer until the votes v are received from the agents 105 at 213, 215 and the activation functions a have been modified in block 217. Subsequent to modification of the activation functions a in the model steering layer(s), the machine learning model 107 may then resume the forward pass of the model steering layer and any subsequent layers, thereby generating the decision v_{c}. Enabling the forward pass to begin before agents 105 have completed voting and/or the votes v have been aggregated enables these actions to be performed in parallel. Performing these actions in parallel, reducing the time required to generate the command v_{c}.

In some examples generating the command v_{c} may comprise decoding the output of the machine learning model 107. In some examples decoding the output of the machine learning model 107 may comprise sampling. In some examples, decoding the output of the machine learning model 107 may comprise sampling based on a seed value.

In the example of FIG. 2, at 223 the machine learning model 107 provides the generated command v_{c} to the agents 105a, 105b. In the example of FIG. 2, the command v_{c} is provided to the second agent 105b via the first agent 105a. In some examples, the command v_{c} may be provided directly to each of the one or more of the agents 105. The method therefore comprises the agent(s) 105 receiving a command v_{c} from the machine learning model 107

In the example of FIG. 2, in block 225 one or more of the machine learning model 107 and/or the agents 105 perform a verification process. In examples where the number of votes cast by each agent 105 are limited, the verification procedure may comprise determining that the number of votes cast by the agents 105 are within the limit(s). In some examples, where the machine learning model 107 receives individual votes from the agents 105, the verification process may be performed by the machine learning model 107. In such examples, the verification process may be performed by the machine learning model 107 prior to modifying the activation functions in block 219. In some examples, the machine learning model 107 may provide the votes assigned by the first agent 105a to the second agent 105b, such that the second agent can determine that the votes cast by the first agent are within the limit (and the votes assigned by the second agent 105b could be provided to the first agent 105a) for a similar purpose. The skilled person would appreciate that the verification process performed by an agent 105 could be in relation to votes assigned by one or more other agents 105. In some examples the agents 105 may provide their votes to the other agents 105 to enable one or more of the agents 105 to perform the verification process. In some examples, the verification process may be performed by the agents 105, before the votes are transmitted to the machine learning model 107 (e.g., at 213 and 215). The method therefore optionally comprises the agent(s) 105 determining whether the respective votes v of each of a plurality of other agents 105 are within respective predetermined limits.

In some examples, the verification process comprises one or more agents 105 repeating the method of the machine learning model 107 using local copies of the machine learning model 107′ hosted by the agents 105. These agents 105 are then able to verify that the command provided by the machine learning model 107 corresponds to the votes v each agent 105 alleges to have provided. This verification process helps to identify scenarios in which a malicious agent 105 generates and provides votes v outside the limit to the machine learning model 107, and then informs the other agents 105 that the votes v provided were within the limit. This scenario would result in a discrepancy between the command v_{c} provided by the machine learning model 107 and the local copies of the machine learning model 107′. In examples where sampling based on a seed value is used to decode the output of the machine learning model 107, the machine learning model 107 may provide the seed to the agents 105.

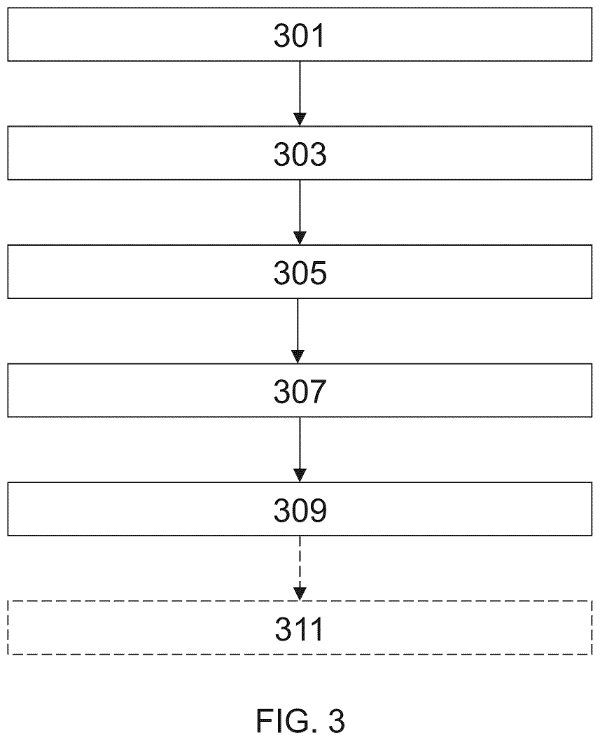

FIG. 3 shows an example computer-implemented method at a machine learning model 107 in a multi-agent collaboration system 101, as shown in FIGS. 1 and 2.

In the example of FIG. 3, in block 301 the method comprises receiving a task prompt as an input to the machine learning model 107. The skilled person would appreciate that block 301 may correspond to 203 in FIG. 2.

In some examples, the task prompt is jointly determined by two or more of the plurality of agents.

In the example of FIG. 3, in block 303 the method comprises determining an aggregated vote v_{agg} corresponding to a model steering value x, wherein the aggregated vote v_{agg} is based on respective votes of each of a plurality of agents 105, each of the plurality of agents 105 being a computer-implemented agent. In some embodiments the method further comprises receiving individual votes v from the one or more agents 105, and determining the aggregate vote v_{agg} comprises using an aggregation method to calculate the aggregated vote v_{agg}. In some embodiments, the machine learning model 107 receives an aggregated vote v_{agg}, and determining the aggregated vote v_{agg} comprises receiving the aggregated vote v_{agg}. The skilled person would appreciate that block 303 may correspond to block 217 in FIG. 2.

In some examples, the aggregation method further comprises normalizing the aggregated vote v_{agg} Normalizing the aggregated vote v_{agg} ensures that each model steering value x has a similar impact when its corresponding activation function(s) a are modified.

In some examples, the aggregation method utilizes one or more cryptographic protocols such that the respective votes v from each of the plurality of agents 105 are aggregated without being individually observable. In some examples, the cryptographic protocols comprise SecAgg (Secure Aggregation) protocols. The use of cryptographic protocols provides improved privacy for agent 105 votes v.

In some examples, a vote v of an agent is a numerical value corresponding to the model steering value x, and a cumulative total of votes v generated by each agent 105 is within a respective predetermined limit. In some examples the respective predetermined limit is one or more of: the same for each of the plurality of agents; the same for one or more of the plurality of agents; different for one or more of the plurality of agents; different for each of the one or more plurality of agents. Applying a limit to the numerical value vote enables a fairer approach to incorporating agent decisions by ensuring that an individual agent is not capable of unduly skewing the task favor towards a particular model steering value. Applying the same limit for each agent ensures that the overall contribution of no individual agent is greater than any other agent. Applying different limits for one or more/each agent may be useful where the task necessitates such (e.g., a tie-break scenario).

In some examples, the machine learning model 107 determines the respective predetermined limits. In some examples, the machine learning model 107 determines the respective predetermined limits by one or more of: generating the predetermined limits; retrieving the limits from storage and/or memory. In some examples, the machine learning model 107 determines the respective predetermined limits by receiving the respective predetermined limits from one or more of the plurality of agents 105 and/or another entity. In examples where the machine learning model 107 receives the respective predetermined limits from one or more of the plurality of agents 105, the plurality of agents 105 may determine the respective predetermined limits by one or more of: by communicating with the other agents 105; retrieving the respective predetermined limits from storage and/or memory.

In some examples, the computer-implemented agent 105 is at least partially autonomous.

In the example of FIG. 3, in block 305 the method comprises modifying an activation function a of one or more artificial neurons in a layer of the machine learning model 107 based upon: the aggregated vote v_{agg}; and a mapping between the activation function a and the model steering value x. Modifying an output of one or more artificial neurons may comprise modifying an activation function a of the one or more artificial neurons. The skilled person would appreciate that block 305 may correspond to block 219 in FIG. 2.

In some examples, the layer having the modified activation function a′ is a model steering layer, the model steering layer comprising one or more artificial neurons which provide outputs relevant to a particular concept and wherein the model steering value x is selected to emphasize or deemphasize outputs related to the particular concept.

In some examples, modifying the activation function a comprises scaling the activation function a mapped to the model steering value x based on the aggregated vote v_{agg} corresponding to the model steering value x. Scaling the activation function based on the aggregated vote v_{agg} enables the steering weight to be proportional to the vote v for a model steering value x, thereby enabling more popular model steering values x to be weighted more heavily.

In the example of FIG. 3, in block 307 the method comprises generating a command v_{c} based upon the output of the layer having the modified activation function a′. The skilled person would appreciate that block 307 may correspond to block 221 in FIG. 2.

In some examples, generating the command v_{c} comprises one or more subsequent layers of the machine learning model 107 processing the output of the layer having the modified activation function a′ during a forward pass.

In some examples, generating the command v_{c} comprises providing the task prompt as input to the machine learning model 107 to begin a forward pass; pausing the forward pass at the layer until the aggregated vote v_{agg} is determined; modifying the activation function a of the one or more artificial neurons in the layer; and obtaining the output of the layer having the modified activation function a′. Allowing the forward pass to begin before agents 105 have completed voting and/or the votes have been aggregated enables these actions to be performed in parallel. Performing these actions in parallel may reduce the time required to perform the method.

In the example of FIG. 3, in block 309 the method comprises providing the command v_{c} to one or more of the plurality of agents 105. The skilled person would appreciate that block 309 may correspond to block 223 in FIG. 2.

In some examples, the task prompt and the command v_{c} relate to a task, and the task is one or more of: a real-world task; performed by a mechanical agent. In some examples, the model steering value x and/or the command v_{c} comprises one or more of: operating parameters; design parameters; processing parameters.

In the example of FIG. 3, block 311 is optional. In block 311 the method further comprises determining whether the respective votes v of each of the plurality of agents 105 are within respective predetermined limits. Responsive to determining that a vote v is outside the limit, block 311 may further comprise performing one or more of: scaling the vote v such that the vote is within the respective predetermined limit; rejecting the vote v; requesting a new vote v. The skilled person would appreciate that block 311 may correspond to block 225 in FIG. 2.

Determining whether the respective votes v of each of the plurality of agents 105 are within respective predetermined limits (i.e., performing a verification process) reduces the risk that a malicious agent 105 cheats (i.e., unduly skews the command v_{c} towards a result) by generating more votes v than is permitted by the limit. Performing one of the above actions in response to determining that a vote v is outside the limit ensures that the task is not unduly skewed by the impermissible vote v.

In general, the machine learning models described herein, such as the machine learning model 107 and the agents 105, can have any appropriate architecture for processing inputs to generate an output. As one example, the machine learning models may comprise an auto-regressive generative model that can auto-regressively generate an output sequence based on the input. The generative model can, for example, comprise a large language model (LLM) that can auto-regressively generate tokenized representations of text data, a vision-language model (VLM) that can auto-regressively generate tokenized representations of image or video data, e.g. in response to a text input or that can auto-regressively generate tokenized representations of text, e.g. in response to an image input, an audio language model that can auto-regressively generate tokenized representations of text data, or a multimodal model that can that can generate tokens representing any of text, image or audio, e.g. in response to a input comprising any of text, image or audio, and so forth. As one example, the generative model may comprise one or more (self-) attention layers, e.g., a Transformer model.

That is, the machine learning models described herein may comprise a neural network characterized by having a succession of attention neural network layers (e.g. a self-attention neural network layer). A self-attention neural network layer has an attention layer input for each element of the input sequence and is configured to apply an attention mechanism over the attention layer input to generate an attention layer output for each element of the input sequence. The attention layer input and the attention layer output may comprise vectors of the same dimension, and the attention neural network layers may have residual connections. There are many different types of attention mechanisms that are suitable for use with the techniques described herein, such as self-attention, multi-headed attention, cross-attention, etc. A self-attention layer can be one that maps a query and a set of key-value pairs, each derived from an input to the self-attention layer (e.g. all vectors), to an output from which an output of the self-attention layer is derived. The output can be computed as a weighted sum of the values, weighted by a similarity function of the query to each respective key.

As an example, in a self-attention neural network layer an input embedding may be used to determine a query vector and a set of key-value vector pairs, that are used to generate an updated embedding comprising a weighted sum of the values, weighted by a similarity function of the query to each respective key. The similarity function may comprise, e.g., a dot product, cosine similarity, or other similarity measure; the query, keys, and values may all be vectors. For example the attention mechanism may be configured to apply each of a query transformation e.g. defined by a matrix W^{Q}, a key transformation e.g. defined by a matrix W^{K}, and a value transformation e.g. defined by a matrix W^{V}, to the attention layer input for each element of an input sequence X to derive a respective query vector Q=XW^{Q}, key vector K=XW^{K}, and value vector V=XW^{V} which are used determine an attended sequence for the output.

As described herein, the inputs and outputs may comprise tokens. In some implementations, the tokens can represent text, e.g., words, wordpieces or characters, in a natural or computer language. For example, text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g. having one or more (self-) attention layers, such as a Transformer neural network as previously described.

Also or instead the tokens may represent an audio waveform. For example, a set (sequence) of input or output tokens can represent audio data representing a waveform e.g. instantaneous audio amplitude values or time-frequency audio data. Each image token may comprise a block encoding of the audio waveform in a different time segment of the audio that maps a set of values representing the audio waveform to a respective image token.

As described herein, the agents may comprise a machine learning model such as a language model. A language model neural network is a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data.

A language model neural network can be made to perform a particular task by providing a natural language description of the desired response as an input or “prompt”. In some cases, the prompt may be a few-shot prompt where a few, e.g., 1 to 10, examples of a query and an example output are provided in the text prior to the actual query.

Instead or in addition, a language model neural network may be “fine-tuned” to perform a particular task, by obtaining a pre-trained language model neural network trained on a large corpus of examples as previously described and then further training part of all of the language model neural network on a relatively small number of examples particular to the type of task that is to be performed.

The language model neural network may be a large language model neural network, e.g., one that has greater than 1 billion, 10 billion or 100 billion trained parameters. The language model neural network may have been trained on greater than 10 billion, 100 billion or 1000 billion words or tokens representing words or other text tokens, e.g., sub-words (also known as “word pieces”).

In some implementations, the language model neural network is an autoregressive transformer neural network as previously described.

The task, as referred to herein, may include any suitable task that may be performed based upon the command v_{c}. The task may include a classification task such as classifying based upon the task prompt (i.e. text classification, image classification, audio classification, video classification, sensor classification, or time-series classification). For example, the task prompt could be time-series data and the task could be to classify that time-series data into one or more categories by outputting categorical data. The task may include a control task for a robotic device. For example, the command v_{c} may include signal data that causes the robotic device to be controlled (i.e. by providing the signal data to the robotic device). The task may include a machine translation task. For example, the task prompt could include text data representing text in a first language and the command v_{c} could include text data representing a natural language translation of that text in a second language. The task may include a summarization task. For example, the command v_{c} could be text data indicating a summary of some text represented by the task prompt. The task may include a question-answering task. For example, the task prompt could include text data indicating a question “What is this a picture of?” and image data indicating an image of an elephant. In this example, the command v_{c} may be text data indicating a response to the question including an answer that indicates “The picture is of an elephant”, or indeed the command v_{c} could be categorical data indicating a classification of an elephant. The task may include a generation task, i.e. a task for generating data. For example, the task prompt may be image data indicating an image of an elephant and the command v_{c} may be video data indicating a video of the elephant, i.e. where the first agent 100 has been trained to generate videos based upon images. The task may include a signalling task. For example, the task prompt could be audio data indicating a user speaking the words “Please schedule a meeting for next Monday” and the command v_{c} could be a signal to a client device of the user which causes a meeting to be scheduled in a digital calendar of the client device.

The agent(s) 105 may be trained to perform tasks such as placing reservations (e.g. travel reservations) on behalf of users (e.g. using signal data for a signalling task), understanding different natural languages, understanding many technical, scientific, or mathematical concepts, etc. In some examples, the agent(s) 105 may be personal agent(s) for a user of a client device. The agent(s) 105 may be implemented on the client device. The agent(s) 105 may be configured to control operation of the client device (e.g. using the signal data) in response to input (e.g. input provided to the agent(s) 105 by the user), e.g. for placing reservations on behalf of the user. The other agent(s) 105 may, in some examples, not be a personal agent and may therefore be implemented elsewhere (e.g. on a server). However, in other examples, the other agent(s) 105 may be a personal agent for another person other than the user. In some examples, the agent(s) 105 may interact with the other agent(s) 105 to perform various tasks, e.g. by gathering information relevant to the other person. The agent(s) 105 can generate command v_{c} that takes into account information relevant to the other person, e.g. such that a meeting can be scheduled in the client device of the user that does not conflict with either person's calendars.

The robotic device, as described above, may take various forms, including but not limited to a telepresence robot, a robotic arm, a bi-arm robotic device, a humanoid robot or other bipedal robot, a quadraped robot such as a “robot dog”, a wheeled robot, an aquatic robot, and so forth. The robotic device may include control logic. Control logic may take various forms, such as a real time controller, one or more processors, one or more field-programmable gate arrays (“FPGA”), one or more application-specific integrated circuits (“ASIC”), and so forth. In some implementations, the logic may be operably coupled with memory. Memory may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, the control logic may be operably coupled with one or more joints, one or more end effectors, and/or one or more sensors. A joint of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. An end effector may broadly refer to a variety of tools that may be operated by the robotic device in order to accomplish various tasks. For example, an end effector may take the form of a claw with two opposing “fingers” or “digits.” Such a claw is one type of “gripper” known as an “impactive” gripper. The gripper may have more than two digits, for example, three, four or five digits. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, the end effector may be removable, and various types of modular end effectors may be installed onto a robot. Some robots, such as some telepresence robots, may not be equipped with end effectors.

Large-scale language models implemented as neural networks can produce impressive results on a range of natural language processing tasks, including question answering. However, implementations of some of these models, particularly Transformer-based models, can have more than a billion parameters and can require substantial computing resources, power, and time to process a network input to generate the network output. Sometimes such models can have can more than 10 billion or more than 100 billion parameters. If such models were used at scale, e.g. in the way that search engines are, there could also be environmental considerations.

An additional consideration arises when the neural network is implemented on a digital assistant device, e.g., a mobile device, implemented in a computing system that includes a back end component, in particular a data server, in communication with the digital assistant device over a data communications network such as the Internet. There is then a need to optimize the computing load between the digital assistant device and the back end component. This need can be particularly acute with a large-scale language model because of its substantial memory and computing requirements compared with those typically found on a mobile device.

The techniques described herein address these problems. In some implementations the described techniques facilitate a reduced a computational load, and improved load distribution, particularly when the large-scale language model is implemented as a neural network in a multitasking and parallel processing computer system, distributed across multiple sites and interconnected by a data communication network, such as the multi-agent system described herein.

In some implementations the described techniques enable a beneficial distribution of computing load between a local, mobile computing device and a back-end server in a network. More particularly, in implementations, by training the agents, e.g. the first agent 100, for multi-agent collaboration and with agent dropout, utilization of other agents and thus computational load may be managed more effectively.

In some implementations the ego agent may be implemented on a digital assistant device such as a mobile device. In such implementations the ego agent can be implemented (wholly) on the mobile device. Subsequent inputs (e.g. the second input data 112) can be processed using a back-end data server by the other agents for multi-agent collaboration, as previously described, which may be implemented using a parallel and distributed computing system. The mobile device generally has less working memory than the back-end data server, less computational capacity than the back-end data server, or both. Computational capacity can be measured in computing operations per second, e.g. FLOPS (floating point operations per second). In this way the computational load can be optimized, particularly where the neural network comprises an autoregressive, Transformer-based neural network. This in turn can facilitate using a smaller language model, e.g. one with fewer than 10 bn parameters, e.g. 7 bn parameters, 1 bn parameters, or fewer.

In general, the agent and/or multi-agent system as a whole, once trained on a large corpus of data, and even without fine tuning, can perform a wide range of tasks. After such training, the agent(s) can be deployed for use in performing the task(s). For instance, the agent(s) can be deployed in an environment that enables users to provide requests for the agent(s) to process specified multimodal inputs to generate corresponding outputs. Users can provide the requests, e.g., by way of a user interface or through an application programming interface (API). The requests can be transmitted from a user device (e.g., over a data communication network, e.g., the internet) to one or more computers implementing the system, e.g., in a data center. The agent(s) can process multimodal inputs specified by user requests to generate corresponding outputs, and then transmit the outputs to user devices (e.g., over a data communication network).

In some examples, the command v_{c} may be configured to have an effect on an environment. The environment may be a physical environment. A physical environment may refer to any type of physical system including, e.g., a fluid, a rigid solid, a deformable material, any other type of physical system or a combination thereof.

For example, the agent can be a robot manipulating objects in the environment. As another example, the agent can be an autonomous vehicle navigating through the environment.

In some cases, the above described systems and methods may be used for design optimization. A method of designing the article may then comprise adjusting the design parameters according to one or more design criteria for the object, e.g. to minimize stress in the object when subject to a force or deformation e.g. by including a representation of the force or deformation in the data defining the state of the physical environment. The process may include making a physical object with the optimized design parameters. The physical object may be e.g. for part of a mechanical structure.

For example, if the design parameters represent a shape or structure of a physical object (e.g., an aircraft wing), then the design parameters can be provided for use in manufacturing an object having the design defined by the design parameters. The object can be manufactured using any appropriate manufacturing process, e.g., a machining process or an additive manufacturing process. In particular, the system can implement an appropriate manufacturing process to manufacture an object having the design defined by the design parameters. As another example, if the design parameters define the design of a process, e.g. a chemical process or a mechanical process, then the design parameters can be provided for use in implementing a process having the design defined by the design parameters. In particular, the system can implement a process having the design defined by the design parameters. When the design parameters define the shape or configuration of a physical object, the method can include making a physical object to a design specified by the design parameters.

In some cases, the design parameters can define, e.g., a shape of an object, e.g., all or part of a vehicle, e.g., a car, a truck, an aircraft, a watercraft, a rocket, etc. In particular examples, the design parameters can define the shape of a wing of an aircraft or the shape of a hull of a watercraft. The design parameters can define the shape of an object, e.g., by defining a respective position of each control point in a set of control points that parametrize the shape of the object, or by defining the vertices and edges of a mesh representing the shape of the object. The system may simulate, e.g., fluid (e.g., air) dynamics in an environment. For example, the system can simulate a stress field or a pressure field in an environment, e.g., that defines a respective stress or pressure at each position in a grid or mesh spanning the environment. A feasibility criterion may be a measure of one or more aerodynamic features of the object (e.g., a drag coefficient or a lift coefficient of the object), or a measure of physical stress or force exerted on the object under specified environment conditions (e.g., the maximum stress exerted on any part of the object). A design criteria may be a measure of one or more aerodynamic features of the object (e.g., a drag coefficient or a lift coefficient of the object), or a measure of physical stress or force exerted on the object under specified environment conditions (e.g., the maximum stress exerted on any part of the object).

In some cases, the design parameters can define, e.g., a structure of an object, e.g., of a vehicle, a bridge, or a building. In particular examples, the design parameters can define the structure of the chassis or frame of a vehicle, or the structure of supports within a bridge or building. The design parameters can define the structure of an object, e.g., by representing the positions, orientations, thicknesses, and connectivity of rods, beams, struts, and ties defining the structure of the object. The system may simulate, e.g., structural mechanics in an environment. For example, the system may simulate a force, stress, or pressure field, e.g., that defines a respective force, stress, or pressure at each position in a grid or mesh spanning the structure. A feasibility criterion may represent e.g., the behavior of the structure under a mechanical load, e.g., a maximum force, stress, or pressure on any part of the structure under the mechanical load. A design criteria may represent e.g., the behavior of the structure under a mechanical load, e.g., a maximum force, stress, or pressure on any part of the structure under the mechanical load.

In some cases, the design parameters can define, e.g., a composition of a material, e.g., an alloy. In particular examples, the design parameters can define the composition of a material, e.g., by defining, for each of multiple possible constituent materials, a fraction of the material that is represented by the constituent material. The system may simulate, e.g.: changes in the chemical composition of the material over time resulting from specified environmental conditions; or a force, stress, or pressure field representing force, stress, or pressure at each position in a grid or mesh spanning an object made of the material. A feasibility criterion may characterize, e.g., corrosion of the material over time, or behavior of an object made of the material under a mechanical load. A design criteria may characterize, e.g., corrosion of the material over time, or behavior of an object made of the material under a mechanical load.

In some cases, the design parameters can define a design of a chemical process, e.g., defining when and how various chemicals should be combined in a chemical process. For example, the design parameters can define the speed of a mixer that agitates the contents of a vat, and for each chemical in a set of chemicals, when the chemical should be added to the vat and in what amount. The system may simulate, e.g., chemical dynamics within an environment. For example, the simulation neural network can simulate a concentration field in an environment, e.g., that defines a respective concentration of each of one or more chemicals at each position in a grid or mesh spanning the environment. A feasibility criterion may measure, e.g.: a yield of the chemical process, e.g., an amount of a desired end product that is produced as a result of the chemical process; or a quality (e.g., purity) of the end product. A design criteria may measure, e.g.: a yield of the chemical process, e.g., an amount of a desired end product that is produced as a result of the chemical process; or a quality (e.g., purity) of the end product.

In some cases, the design parameters can define a design of a mechanical process, e.g., defining, for each fan in an environment (e.g., a mine): (i) a rotational speed of the blades of the fan, and (ii) an orientation of the fan. The system may simulate a flow field in the environment, e.g., that defines a respective direction of airflow, strength of airflow, and concentration of gasses at each position in a grid or mesh spanning the environment. A feasibility criterion may characterize, e.g., a distribution and concentration of one or gasses (e.g., oxygen) in the environment, e.g., as a result of the operation of the fans. A design criterion may characterize, e.g., a distribution and concentration of one or gasses (e.g., oxygen) in the environment, e.g., as a result of the operation of the fans.

Some implementations comprise a method of controlling an agent to perform one or more tasks while interacting with an environment.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g. robot, may be interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle. The actions may be language actions that are in turn used to generate control data to control the robot or other mechanical agent.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g. a monitoring system such as a video camera or sound capture system, to capture visual observations of the user performing the task. The actions may comprise instructions in the form of, e.g., text, image, video, or audio data such as speech, that guide the user in performing the task. Thus the observations are observations of a real-world environment in which a human is performing a task, e.g. an image observation from an image sensor and/or a language observation from a speech recognition system; and the actions are language actions that control (instruct) the human, e.g. using natural language or images, to perform actions in the real-world environment to perform the task. A language action may be an action that outputs a natural language sentence, e.g. by defining a sequence of language tokens, e.g. words or wordpieces, to be emitted at sequential time steps. Thus the agent may comprise a user interface device such as a digital device (a “digital assistant”), e.g. a smart speaker or smart display or other device, e.g. with a natural language input and/or output, that controls (instructs) a human user to perform a task. In general such a digital device can be a mobile device with a natural language interface to receive natural language requests from a human user and to provide natural language responses. It may also include a vision based input e.g. a camera and/or display screen. The digital device may include a language model or language generation neural network system either stored locally, or accessed remotely, or both. The user interface device may comprise, e.g., a mobile device, a keyboard (and optionally display), or a speech-based input mechanism, e.g. to input audio data characterizing a speech waveform of speech representing the input from the user in the natural or computer language and to convert the audio data into tokens representing the speech in the natural or computer language, i.e. representing a transcription of the spoken input. The user interface can also include a text or speech-based output, e.g. a display and/or a text-to-speech subsystem. Thus in implementations the agent actions contribute to performing the task. A monitoring system, e.g. a video camera system, may be provided for monitoring the action (if any) which the user actually performs at each time step in case, e.g. due to human error, it is different from the action which the reinforcement learning system instructed the user to perform. The monitoring system can be used to determine whether the task has been completed. Training data may be collected by recording the actions which the user actually performed based on the instruction.

In some implementations the environment is a real-world manufacturing environment for manufacturing a product, such as a chemical, biological, or mechanical product, or a food product. As used herein, “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In general, observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples, such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

In some implementations, the environment is a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound, i.e. a drug, and the agent is a computer system for determining elements of the pharmaceutically active compound and/or a synthetic pathway for the pharmaceutically active compound. The agent may be, or may include, a mechanical agent that performs or controls synthesis of the pharmaceutically active compound; and hence a process as described herein may include making such a pharmaceutically active compound.

For example the environment may be an in silico drug design environment, e.g., a molecular docking environment, and the agent may be a computer system for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. A measure of interaction between the drug and drug target may depend on e.g. a protein-ligand bonding, van der Waal interactions, electrostatic interactions, and/or a contact surface region or energy; it may comprise, e.g., a docking score. Following identification of elements or a chemical structure of a drug in simulation, the method may further comprise making the drug. The drug may be made partly or completely by an automatic chemical synthesis system.

In some implementations the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some implementations the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach.

In some implementations, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources.

In some implementations the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability.

In some other implementations the environment is an Internet or mobile communications environment and the agent is a software agent which manages a personalized recommendation for a user. The observations may comprise previous actions taken by the user, e.g. features characterizing these; the actions may include actions recommending items such as content items to a user. As a further example, the actions may include presenting advertisements, the observations may include advertisement impressions or a click-through count or rate.

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The design process may include outputting the design for manufacture, e.g. in the form of computer executable instructions for manufacturing the entity. The process may include making the entity according to the design. Thus the design of an entity may be optimized, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment. In the above described applications the same observations, and actions may be applied to a simulation of the agent in a simulation of the real-world environment. Once the system has been trained in the simulation, e.g. once the neural networks of the system/method have been trained, the system/method can be used to control the real-world agent in the real-world environment. That is control signals generated by the system/method may be used to control the real-world agent to perform a task in the real-world environment in response to observations from the real-world environment. Optionally the system/method may continue training in the real-world environment.

In some implementations, the system may be used for control or prediction of multiple agents. For example, entities in the environment may be natural or man-made and the environment may be a real-world environment or a simulated real-world environment. Agents may comprise computer-controlled or human-controlled machines such as robots or autonomous land, sea, or air vehicles. Agents may also comprise humans and/or animals. Agents may further comprise static or mobile software agents i.e. computer programs configured to operate autonomously and/or with other software agents or people to perform a task such as configuration or maintenance of a computer or communications network or configuration or maintenance of a manufacturing plant or data center/server farm. For example some implementations of the system may be used for prediction or control or vehicular or pedestrian traffic e.g. for traffic signal control to reduce congestion, or for prediction or control of teams of people performing a task or playing a game e.g., by providing signals to the people based on an output e.g. representation data from the system. In some other implementations the system may be used for cooperative control of robots performing a task such as warehouse or logistics automation, package delivery control e.g. using robots, drone fleet control and so forth. Multiple autonomous or semi-autonomous agents of the type may be controlled to facilitate cooperative behavior in complex environments. In some implementations the agents may be of different types. For example in a warehouse setting autonomous vehicles or warehouse control robots from more than one different manufacturer may be operating.

In some implementations, after training, a particular task that is to be performed by the generative model can be described by part or all of a sequence of text in the input to the system. For example, an input may include an image and an instruction such as “Generate a caption”, “Generate a description”, “Answer the following question: [about the image or video]”, or “Detect a person”. Where the system is used for an agent control task an input may define “Take the knife out of the drawer”, or “Q: What action should the robot take to take the knife out of the drawer?”.

In some implementations, the input may comprise further instructions specifying how to perform a task. In some implementations, the input may comprise one or more examples of the task being performed.

A few examples of some tasks that can be performed by the generative model follow. The tasks may be tasks that require spatial awareness or other context from an input image or video. For example, an input may include the question “What is the object in the top left corner?”. The system may have been pre-trained or trained using supervised fine-tuning on examples of the input and output for the task. For example the system can have been trained using still or moving images containing one or more objects or actions, and corresponding sequences of text or other data e.g. describing or classifying the images.

The generative model can be used for diagnosing a fault, or for correcting undesired behavior, in a mechanical or computing system operating in the real world environment. The input may comprise a description and/or image of one or more observations of the mechanical or computing system, e.g. of operation of the system, optionally obtained from one or more sensors sensing a condition or operation of the system. An image observation may be converted into a text description e.g. using an image captioning system or in other ways. The output may comprise an image, audio, or text that identifies a likely cause of the fault or undesired behavior. This may be used to repair the fault or correct the behavior.

In some implementations the task performed by the generative model comprises an agent control task in which the agent interacts with an environment to perform the agent control task. In particular, the generative model can be used for controlling a mechanical agent such as a robot or vehicle. In these implementations the input can include an observation characterizing the environment. For example the input can include a sequence of text that defines the task to be performed by the agent and the image can represent an observation of the environment, e.g. captured by a camera or other imaging device from a real-world environment. The output can comprise an action selection output, e.g. including text, that is used to select one or more actions to be performed by the agent in the environment in response to the observation. As an illustration the output may define an action as text such as “A: 132 114 128 5 25 156”, that can be converted into a control signal for a mechanical agent, such as a robot. The output may comprise a list of sub-tasks to be performed by the mechanical agent, in order to perform the task. The action selection output may also or instead define one or more low-level skills, e.g. from a vocabulary of previously learnt skills. As before, the sequence of text in the input to the system may describe the task to be performed, e.g. “What action should the robot take to [perform task]”. Examples of systems for controlling an agent that may be fine tuned as described herein can include PaLM-E (Driess et al. arXiv: 2303.03378), RT-1 (Brohan et al. arXiv: 2212.06817), and RT-2 (Brohan et al. arXiv: 2307.15818).

As another example, the task may comprise an object or action detection task. For example the generated output may comprise or represent text that describes or otherwise labels detected object(s) or action(s) in an input comprising an image or audio, and may include coordinates such as bounding-box coordinates for the detected object(s) or action(s), e.g. “10 20 90 100 cat 20 30 100 100 dog”. As another example the task may comprise a classification task, e.g. an object or action classification task. The output may comprise data, e.g. text, that classifies the object(s) or action(s) represented in the input, e.g. in an image or audio, into one of a plurality of classes, or that otherwise classify object(s) or action(s) represented in the input. As another example the task may comprise a still or moving image describing task, e.g. a captioning task (which, as used here, includes an audio description task to explain what is happening in an image). The output may comprise data, e.g. text, describing an image or video in the input. For example the output may provide a caption or description or it may count objects in the image or video, or it may provide some other form of description. As another example the task may comprise a still or moving image question-answering task. The output may comprise data, e.g. text, that answers a question about the input, e.g. an image or audio, where the question is also specified in the input, e.g. as sequence of text. This may be used, e.g., to answer questions about visual plots and charts or about sounds. As another example the task may comprise a character or word recognition task, e.g. an OCR (optical character recognition) task. The input may comprise a still or moving image and the output may comprise text that represents characters or words in the input, e.g. in a natural language.

As another example the task may comprise a still or moving image generation task. The output may comprise image data defining values for pixels of a still or moving image, and the input, e.g. a sequence of text, may describe or characterize the image to be generated. Merely as an example, an image of a plot or chart may be generated to represent the input, e.g. comprising text. As another example the task may comprise a computer language text generation task. The input may comprise a natural language description of a task to be performed, and optionally an image (if the task is to be performed on or in relation to an image), and the output may comprise text in a computer language to perform the task, e.g. a task of analyzing the content of the image to provide a result of the analysis or to search for information relating to the content of the image. In general the task can involve manipulation of particular types of data that may benefit from access to an API such as mathematical data, date/time related data, scientific data, recent data that may post-date training of the system (that may be accessed by a search function or API), and so forth; and the output may comprise text in a computer language for performing the task. The method may then include using the text in the computer language to perform the task.

Optionally, in any of the above implementations, the observation at any given time step may include data from a previous time step that may be beneficial in characterizing the environment, e.g., the action performed at the previous time step.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
receiving a task prompt as an input to a machine learning model;
determining an aggregated vote corresponding to a model steering value, wherein the aggregated vote is based on respective votes of each of a plurality of agents, each of the plurality of agents being a computer-implemented agent;
modifying an activation function of one or more artificial neurons in a layer of the machine learning model based upon:
the aggregated vote; and
a mapping between the activation function and the model steering value;
generating a command based upon the output of the layer having the modified activation function; and
providing the command to one or more of the plurality of agents.

2. The method of claim 1, wherein the aggregated vote is determined using an aggregation method, the aggregation method comprising summing the respective votes corresponding to the model steering value from the plurality of agents.

3. The method of claim 2, wherein the aggregation method further comprises normalizing the aggregated vote.

4. The method of claim 2, wherein the aggregation method utilizes one or more cryptographic protocols such that the respective votes from each of the plurality of agents are aggregated without being individually observable.

5. The method of claim 1, wherein a vote of an agent is a numerical value corresponding to the model steering value, and a cumulative total of votes generated by each agent is within a respective predetermined limit; and
the respective predetermined limit is one or more of: the same for each of the plurality of agents; the same for one or more of the plurality of agents; different for one or more of the plurality of agents; different for each of the one or more plurality of agents.

6. The method of claim 5, further comprising:
determining whether the respective votes of each of the plurality of agents are within the respective predetermined limits; and
responsive to determining that a vote is outside the limit, performing one or more of:
scaling the vote such that the vote is within the respective predetermined limit;
rejecting the vote;
requesting a new vote.

7. The method of claim 1, wherein the task prompt is jointly determined by two or more of the plurality of agents.

8. The method of claim 1, wherein the layer having the modified activation function is a model steering layer, the model steering layer comprising one or more artificial neurons which provide outputs relevant to a particular concept and wherein the model steering value is selected to emphasize or deemphasize outputs related to the particular concept.

9. The method of claim 1, wherein modifying the activation function comprises scaling the activation function mapped to the model steering value based on the aggregated vote corresponding to the model steering value.

10. The method of claim 1, wherein generating the command comprises one or more subsequent layers of the machine learning model processing the output of the layer having the modified activation function during a forward pass.

11. The method of claim 1, wherein generating the command comprises:
providing the task prompt as input to the machine learning model to begin a forward pass;
pausing the forward pass at the layer until the aggregated vote is determined;
modifying the activation function of the one or more artificial neurons in the layer; and
obtaining the output of the layer having the modified activation function.

12. The method of claim 1, wherein the task prompt and the command relate to a task, and the task is one or more of: a real-world task; performed by a mechanical or electronic agent.

13. The method of claim 1, wherein the computer-implemented agent is at least partially autonomous.

14. The method of claim 1 wherein the model steering value and/or the command comprises one or more of: operating parameters; design parameters; processing parameters.

15. A computer-implemented method of performing a task, comprising, at an agent:
determining a task prompt;
providing the task prompt to a machine learning model, configured to provide a command based upon the task prompt;
determining a model steering value;
generating a vote for the model steering value;
providing the vote for the model steering value to the machine learning model; and
receiving a command from the machine learning model.

16. The method of claim 15, wherein the vote for the model steering value is a numerical value corresponding to the model steering value, and a cumulative total of votes generated by the agent is within a predetermined limit.

17. The method of claim 15, further comprising determining whether the respective votes of each of a plurality of other agents are within respective predetermined limits.

18. The method of claim 15, wherein the vote is generated based on a user preference instruction.

19. A system comprising one or more computers and one or more storage devices storing instructions that when executed by one or more computers cause the one or more computers to perform operations comprising:
receiving a task prompt as an input to a machine learning model;
determining an aggregated vote corresponding to a model steering value, wherein the aggregated vote is based on respective votes of each of a plurality of agents, each of the plurality of agents being a computer-implemented agent;
modifying an activation function of one or more artificial neurons in a layer of the machine learning model based upon:
the aggregated vote; and
a mapping between the activation function and the model steering value;
generating a command based upon the output of the layer having the modified activation function; and
providing the command to one or more of the plurality of agents.

20. The system of claim 19, wherein the aggregated vote is determined using an aggregation method, the aggregation method comprising summing the respective votes corresponding to the model steering value from the plurality of agents.
